(19) United States
(12) Patent Application Publication
(10) Pub. No.: US 2005/0086128 A1
(43) Pub. Date: Apr. 21, 2005

(54) Method and apparatus for electronic product information and business transactions

(76) Inventor: Michael E. Shanahan, Nyack, NY (US)

Correspondence Address: LAW OFFICES OF SCOTT H. KALIKO, P.A., 3503 RIO VISTA DRIVE, MAHWAH, NJ, 07430, US

(21) Appl. No.: 11/006,474

(22) Filed: Dec. 7, 2004

Related U.S. Application Data
(63) Continuation of application No. 10/354,232, filed on Jan. 28, 2003.

(51) Int. Cl. G06F 17/60

(52) U.S. Cl. 705/26

(57) ABSTRACT

A shopping aid for electronically supplying product information is provided. In one aspect of the invention, product, sales, status, availability and/or other related product information may be transmitted locally from a computer system associated with a merchant or from the Internet to a portable electronic device of the consumer. The customer may consult the mobile device as a shopping aid to receive current and accurate information about a product, product status and availability or other information such as compatible products and/or services, promotional or other items of interest useful in making purchasing decisions.

### CROSS REFERENCE TO RELATED APPLICATIONS

This application claims the benefit of U.S. patent application entitled “Method and Apparatus for Electronic Product Information and Business Transactions” filed Jan. 28, 2003, Ser. No. 10/354,232 which is hereby incorporated by reference in its entirety.

### BACKGROUND OF THE INVENTION

The present invention relates to electronic business communications and more particularly to methods and apparatus that allow consumers to communicate directly with merchant or other remote computer systems.

Presently, in the “bricks and mortar” business environment, consumers often interface with different types of sales representatives to complete a transaction. For example, if a customer is purchasing electronic equipment such as a DVD player, compatibility, price, interconnection and other product information or advice are given by a technical sales representative whereas payment or account reconciliation information is usually received by a cashier. This traditional sales model, however, presents significant problems and inconveniences to the consumer. For example, technical sales representatives are often difficult to find and frequently aren't familiar enough (or sometimes at all) with a particular product or service to completely and accurately answer the consumer's questions. In fact, in many situations, consumers rely on incorrect, partially incorrect, or conflicting information about a product or service which leads to the purchase of the wrong product, ultimately resulting in consumer dissatisfaction and frustration. In addition, dealing with sales representatives also involves other inconveniences such as waiting on line and interacting with inexperienced sales personnel.

Other business environments that commonly use service personnel also present inconveniences for the consumer. For example, in a restaurant or hotel environment consumers are often forced to rely on service personnel such as waiters to take orders, provide product and status information, recommendations, and, among other things, to furnish the bill at the end of the meal. Frequently, in busy restaurants, consumers are unable to obtain enough of the server's time to adequately answer all questions, make recommendations, repeat information such as daily specials, describe in detail the menu items available including nutritional information, provide status information about when to expect service of ordered items, to refresh, refill or replace certain items such as beverages, condiments, silverware, glasses and to tend to other customers needs such as misdelivered or misprepared items.

In view of these and other shortcomings in the prior art, it would therefore be desirable to provide consumers with an electronic shopping aid to streamline and improve the consumer's shopping experience.

It would also be desirable to provide detailed and accurate product information to a consumer electronically.

It would also be desirable to provide detailed and accurate product information to a consumer without relying on service personnel.

It would further be desirable to allow a consumer to obtain, respond to, and request further product, status, and other related information in an interactive environment.

It would also be desirable to allow a consumer to optionally conduct business transactions and make decisions based on the received information.

### SUMMARY OF THE INVENTION

It is therefore an object of the present invention to provide consumers with an electronic shopping aid to streamline and improve the consumer's shopping experience.

It is therefore another object of the present invention to provide detailed and accurate product information to a consumer electronically.

It is therefore another object of the present invention to provide detailed and accurate product information to a consumer without relying on a service personnel.

It is therefore a further object of the invention to allow a consumer to obtain, respond to, and request further product and other related information in an interactive environment.

It is also a further object of the invention to allow a consumer to optionally conduct business transactions and make decisions based on the received information.

These and other objects of the present invention are accomplished by providing methods and apparatus that allow a consumer to receive and optionally respond to product information transmitted electronically. In one aspect of the invention, product, sales, status, availability and/or other related product information may be transmitted locally from a computer system associated with a merchant or from the Internet to a portable electronic device of the consumer such as a mobile phone, personal digital assistant (PDA), mobile or handheld computer or any other suitable device that combines some or all the features of those devices. The consumer may consult the mobile device as a shopping aid to receive current and accurate information about a product, product status and availability or other information such as compatible products and/or services, promotional or other items of interest useful in making purchasing decisions. This information may be provided in an interactive environment on a display screen of the consumer's electronic device and may include text, image, video, audio or any other suitable form of information in response to the consumer's request. The merchant's computer system may also transmit other related information such as purchasing information that may include price and availability of a selected item. The system may also allow the customer to optionally ship the item by offering payment and delivery options that may be selected and completed using the mobile device, thereby eliminating or significantly reducing reliance on service personnel and ensuring that current and accurate information is provided to the consumer.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 is a generalized block diagram of a system for electronically communicating product and business transaction information to a consumer electronic device in accordance with one embodiment of the present invention.

FIG. 2 is an illustrative embodiment of a front end display screen suitable for use with a retailing application of the present invention.

FIG. 3 is an illustrative embodiment of a product information display screen that may be invoked from the front end screen of FIG. 2.

FIG. 4 is an illustrative embodiment of a selected item and purchase display screen suitable for use with a retailing application of the present invention.

FIG. 5 is an illustrative embodiment of a front end display screen suitable for use in a restaurant application of the present invention.

FIG. 6 is an illustrative embodiment of a product information display screen that may be invoked from the front end screen of FIG. 5.

FIG. 7 is an illustrative embodiment of a selected and purchase display screen suitable for use with a restaurant application of the present invention.

### DETAILED DESCRIPTION OF THE INVENTION

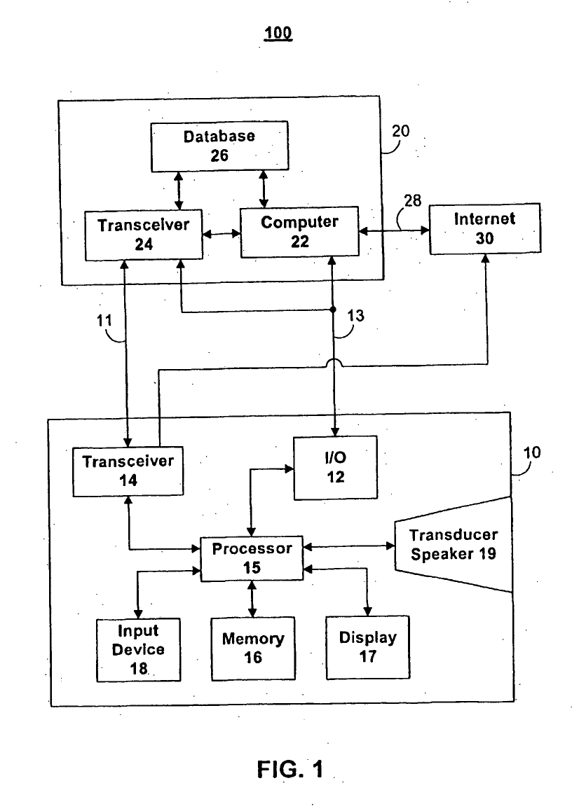

FIG. 1 shows a block diagram of a system 100 for electronically communicating product and business transaction information to a consumer electronic device in accordance with one embodiment of the present invention. As shown in FIG. 1, system 100 generally includes a portable electronic device 10, and a merchant information server 20. Device 10 may communicate with server 20 via wireless link 11, and/or link 13.

Device 10 may be any consumer-owned portable electronic device with external communication capabilities such as a wireless telephone, a pager such as a Blackberry.TM., a handheld computer such as a Pocket PC.TM., personal digital assistant (PDA), etc. Device 10 may also be any device which integrates some or all of the functions of such devices into one device. For example, device 10 may be a PDA or handheld computer with some or all of the functions of a pager and a wireless telephone, etc. In some embodiments, device 10 may be a unit provided by the merchant or a third party to the consumer for use as an electronic shopping aid.

Link 11 is preferably a wireless communication link such as a cellular telephone link, a wireless Internet link, wireless network link, or a wireless modem for receiving information from merchant information server 20 and/or Internet 30. Link 11 may also be any suitable local, short, or intermediate range communications link such as a Bluetooth™ or IrDA infrared link. Any other type of appropriate wireless link may also be used if desired.

Link 13, which is optional, may be a hardwired link for use when wireless communication is not available or desired. Link 13 may be any suitable communications link such as a serial port, a parallel port, a universal serial bus (USB), an RS232, or GPIB link, a digital or analog modem, or a network interface link (e.g., Ethernet links, token ring links, etc.).

As shown, device 10 may include an input/output (I/O) device 12, a wireless transceiver 14, a processor 15, a memory 16, a display 17, a user input device 18, and a transducer/speaker 19. In some embodiments, display 17 and user input device 18 may be integrated into a single unit such as a touch activated screen (not shown). Generally speaking, processor 15 controls the operation of device 10. Functions of processor 15 include, but are not limited to, processing user input, managing and coordinating communications to and from external devices, display functions, reading/writing information to and from memory 16, sending/receiving audio signals to/from transducer 19 etc.

In preferred embodiments, display screen 17 is capable of providing a high resolution color picture, and transducer/speaker 19 is an enhanced performance speaker capable of providing an extended range of realistic audio sounds. However, these features are not required in basic embodiments. User input device 18 may be any type of keypad, mouse, trackball, or any other suitable input device commonly found on the devices described above that allows the consumer to input information to or select information displayed on device 10. As mentioned above, however, input 18 and display 17 may be combined into a single unit such as a touch activated screen (not shown) to save space and/or provide improved ergonomics.

Device 10 may communicate with other electronic devices, such as merchant information server 20, Internet 30, or other devices 10 using wireless transceiver 14. Transceiver 14 is typically selected to be the appropriate communications module for conducting two-way communications in accordance with the particular type of link 11 in use. For example, transceiver 14 may be a Bluetooth™, IrDA, wireless Internet, telephone, modem or other appropriate wireless transceiver. In some basic embodiments, transceiver 14 may be replaced with a one way communications device that merely receives incoming communications (i.e., a receiver, not shown).

To increase compatibility with other systems 100, transceiver 14 that may be reconfigurable or otherwise adaptable to change between various communications standards. This may be accomplished using reconfiguration software, adaptable hardware or a combination of the two. Alternatively, compatibility may be increased by including multiple dedicated transceivers 14 each operating at a different wireless standard (not shown).

I/O device 12 may perform some or all of the functions of transceiver 14 when wireless communication is not available or desired. In this case, I/O 12 may communicate directly with computer 22 or be routed to portions of transceiver 24 or associated circuitry configured to accept such communications.

As shown in FIG. 1, system 100 also includes merchant information server 20. Server 20 includes a computer 22, a wireless transceiver 24, and optionally database 26 and Internet connection 28. Transceiver 24, which is typically configured to communicate with transceivers 14 in device 10 (or vice-versa), may be located in a central area in the merchant's shop to facilitate wireless communication with devices 10. Generally speaking, computer 22 handles product information and other consumer requests received from devices 10 through transceiver 24. For example, a consumer may electronically request product or other information from server 20 using device 10 (discussed in more detail below). That request is received by transceiver 24 and passed along to computer 24 which subsequently processes the request and provides the consumer with the appropriate information (if available). This process may include searching a memory within computer 22 (not shown), consulting with database 26, and/or searching Internet 30 or other computer networks (not shown) for the requested information. After the information is obtained, computer 22 may supervise or simply queue its transmission to device 10 via transceiver 24.

It will be understood that although only one transceiver 24 is shown in FIG. 1, additional transceivers 24 may be placed throughout the merchant's shop as needed to provide the appropriate bandwidth and to ensure proper wireless communication between devices 10 and transceivers 24. Moreover, in some embodiments, multiple transceivers 24 operating with different communications standards or that can be adapted to different communications standards may be deployed to increase compatibility with a wider range of devices 10. Furthermore, although transceivers 24 may be located in various locations throughout the merchant's shop, computer 22, database 26, and Internet connection 28 may be centrally located with transceivers 24 hardwired to that central location. In other embodiments, however, transceivers 24 may report to computer 22 over a wireless link similar to link 11. In this case, computer 22 may include a high bandwidth wireless connection (not shown) to communicate with transceivers 24.

Furthermore, it will be understood that although only one device 10 is shown, system 100 is preferably set up to serve multiple devices 10. In addition, system 100 may be configured for use in a wide variety of shopping environments ranging from large shopping malls or department stores to small businesses. For example, in a large shopping mall, multiple transceivers 24 may be spread out as needed across the mall to provide proper wireless coverage. Computer 22 or multiple computers 22 of sufficient capacity may also be used in this embodiment to process and respond to consumer requests in a timely fashion.

Although system 100 has been described in the context of wireless operation, it will be understood that in certain embodiments, hardwired access points could partially or fully replace transceivers 24 as the conduit through which inquires are transmitted to computer 22. For example, hardwired access points to such links, like those described above in connection with link 13 may be distributed throughout a merchant's shop. When a consumer desires to request product information, he or she would simply connect device 10 to that access point through a cable to I/O port 12 and communicate with computer 22 across that link (e.g., link 13).

The basic framework for information transfer has been set forth above. Some specific applications of system 100 will be described in the following. As mentioned in the background section, one use for system 100 is in retailing. Consumers shopping in a conventional bricks and mortar retail environment often cannot obtain reliable product information from sales representatives. System 100 provides consumers with a way to obtain product information directly from the merchant or manufacturer by consulting with merchant information server 20 or Internet 30. This solves the problem of having to wait for or rely on inexperienced sales personnel.

Assume, for example, that a consumer enters a merchant's location to do some shopping. Upon arrival, the consumer may simply obtain a portable device 10 from the merchant or use any suitable device 10 such as a cell phone, handheld computer, or personal digital assistant (PDA) already in the consumer's possession. Once the consumer has device 10, he or she may passively receive information from or poll server 20 for information by simply turning device 10 on or by following instructions provided by the merchant. For example, if a wireless phone is being used as device 10, the consumer may be instructed to dial a particular telephone number and follow the instructions provided. In this case, the appropriate information may be provided on display 17 and/or through speaker 19. Subsequent communications may be conducted through any link 11 described above (e.g., Bluetooth, IrDA, wireless phone or modem link, etc.).

In other embodiments, simply activating wireless transceiver 14 may be sufficient to communicate with merchant information sever 20. Any suitable connection procedure may be used if desired.

In the case where a portable web browser on device 10 is being used such as wireless application protocol (WAP) compliant browser, the consumer may be instructed to visit a particular web site and follow the instructions found there. In this case, the consumer may access server 20 for information or may communicate directly with Internet 30. In the case where the consumer interacts directly with Internet 30, the user may be initially prompted to identify the store or store location and thereafter be provided with a customized web page(s) with information specifically relating to that store (without having to communicate with server 20). In other embodiments, only general or partially customized information may be available. Such Internet embodiments or web pages may include some or all of the features described herein in conjunction with system 100.

Once communication is established, the consumer may receive a wide variety of information relating to the merchant's goods and services on display 17. This information may include, but is not limited to, items on sale, promotional items, credit offers, special advertising or any other merchant related information. If desired, the consumer may identify himself (i.e., “log on” to the merchants system) by providing some identification to server 20 such as a user name and password, an electronic serial number (ESN) or some other form of identification (or remain anonymous). Should the consumer identify himself, server 20 may have a record of the consumer's customer profile and provide other information to device 10 such as a record of past purchases, sales or promotional offers based on the profile, targeted advertising or solicitation, etc.

At this point, the consumer may select a “product information” option listed on the retailer's introductory screen and thereafter may use device 10 to obtain accurate, complete, and specific product information without the need of a sales representative. For example, assume while shopping a consumer selects a particular product and desires additional information. Using system 100, the consumer may input or scan a product description into device 10 and receive product information back from server 20 in response to the inquiry.

Aspects of this process may be carried out in various ways. For example, entry of the product description may be accomplished using the keypad (input device 18), by selecting the appropriate item(s) listed on a menu shown on display 17 or by “scanning in” product information using a barcode or other optical, magnetic or RFID scanner installed on device 10 (not shown) to read such a description encoded on or near the product of interest. However, any other suitable data entry method may be used if desired.

Once the product has been identified or a query formulated, server 20 or Internet 30 may search for responsive information and provide it to the consumer via wireless link 11. This information may be displayed on device 10 for consumer review. The consumer may continue to pose further and more specific inquiries to server 20 until a satisfactory response is received or the information is found to be unavailable. As can be seen from the above, system 100 provides an interactive environment through which a consumer may obtain focused product information without relying on service personnel. The search environment may be set up in a number of ways currently known in the art. For example, in response to a product inquiry, server 20 may simply provide electronic versions of a product overview, brochure, feature list, or owner's manual for the consumer to peruse. In other embodiments, however, system 100 may provide other popular searching capabilities such “word searching,” or “boolean searching,” as often found on Internet search engines such as Google™ or may support the more sophisticated “natural language searches” commonly found on Lexis™ and Westlaw™. Results of such searches may be displayed in order of relevancy on device 10 for consumer review. Other embodiments may include an interactive menu system with products broken down by category. In this case, the consumer may select predefined options from a menu without needing to enter specific information. Other embodiments may provide a combination of these features.

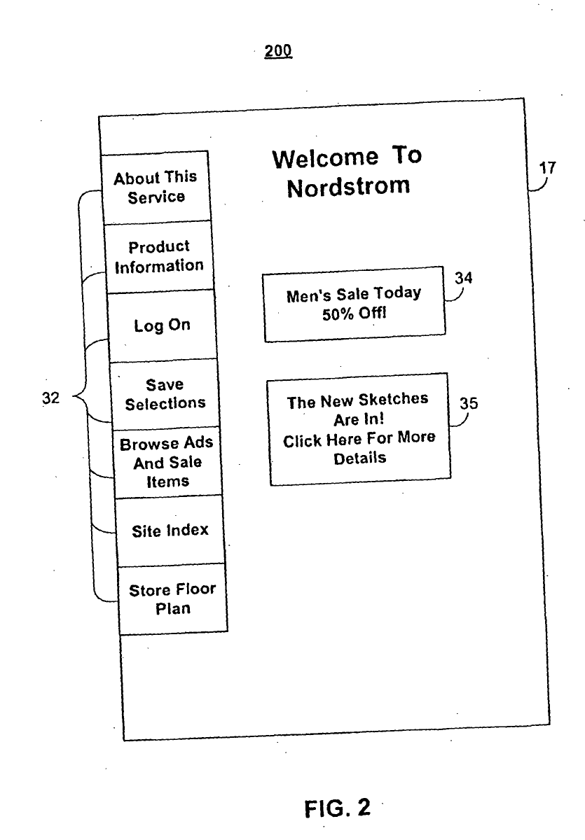

In operation, system 100 may provide a menu driven “front end” screen to device 10 that allows the user to choose from among various feature options. In FIG. 2, one possible embodiment of front end screen 200 is shown as presented on display 17. As shown, screen 200 may include text, image, (and audio or video) or other greeting displays including the company name or logo as well various advertising displays 34 and 35. On the left-hand side of screen 200, a group of feature fields 32 are shown. From the options on this introductory screen, the consumer may choose from among various system features by selecting from the feature fields 32. This may be done by highlighting a particular field 32 and selecting it using input device 18 or if screen 17 is a touch screen by simply pressing the appropriate field. In other embodiments, the consumer may select a field 32 via voice activation through transducer/speaker 19.

Static banner field 34 may display generic or targeted advertising or other promotional offers. Banner 35 may be an interactive banner that can be selected to obtain more information about a displayed promotion or offer.

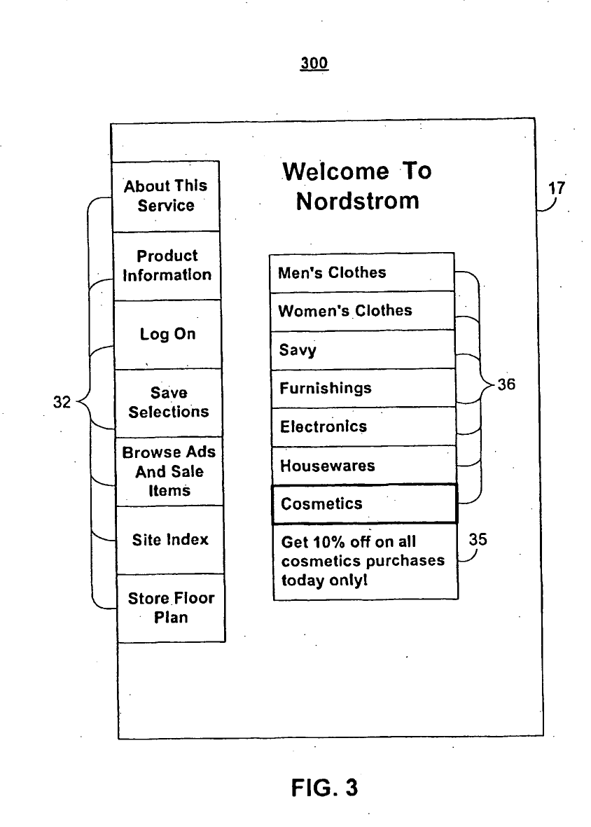

As shown, the consumer may choose various available features to streamline or improve the consumer's shopping experience. For example, selecting the “About This Service” field may provide information on how to use system 100 and what type of information and services are available through it. Selecting the “Product Information” field may allow the user to obtain additional information about a selected product or service. This may be done using the searching methods described above, or by selecting from among a list a of categories of products. An example of the latter method is shown in FIG. 3 as screen 300. As shown, the consumer may select from the displayed categories 36 and may continue search within that category (through subsequent more specific menus (not shown) for information about a particular product.

Also shown in FIG. 3 is promotional banner 35. This banner may appear as the consumer scrolls down the list of category fields 36 to advertise promotions or other events or sales in that category. For example, in FIG. 3, the “Cosmetics” category is shown highlighted. In this embodiment, banner 35 contains information regarding a cosmetics promotion. In some embodiments, banner 35 may remain in synchronization with the highlighted category, displaying information about events in the highlighted category. However, in other embodiments, banner 35 may change at regularly timed intervals, or may remain unchanged. Furthermore, banner 35 may be interactive such that the user may click on or select the banner to obtain more information.

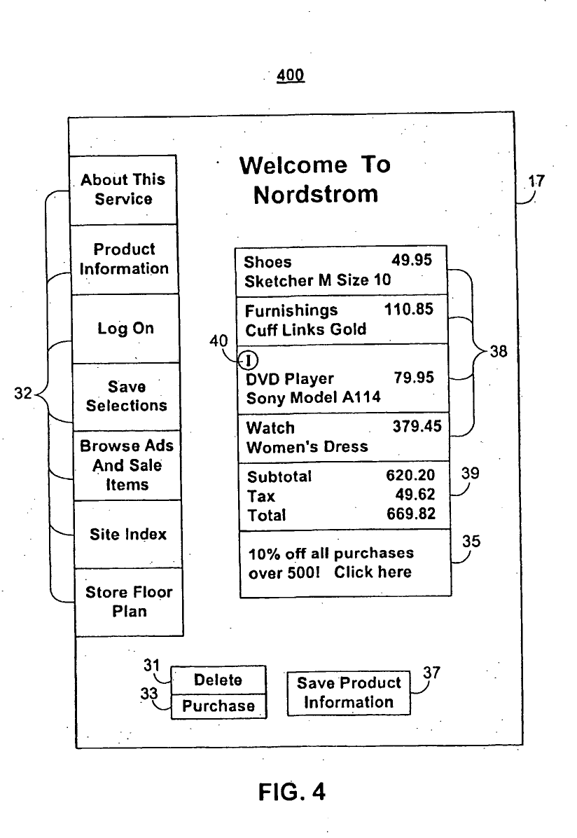

Returning now to feature fields 32, the consumer may choose the “Log On” feature to enter and receive additional promotional, sales, credit, or other “valued customer” information based on a consumer profile that the merchant may maintain about certain consumers (not shown). Choosing the “Save Selections” option may prompt system 100 to create and keep track of a list of selected items along with price and a running purchase total so the consumer may be cognizant of total spending. This is shown in FIG. 4. As shown, screen 400 may include a delete button 31, a purchase button 33, banner 35, a save product information button 37, item fields 38, and a total field 39. As a consumer selects items by scanning or data input, corresponding item fields 38 may appear on screen 400 with a brief product description and price information for the selected product. Total field 39 displays the total purchase price of the selected items. The consumer may purchase all the listed item(s) by pressing purchase button 39 or may purchase some of the listed items by scrolling through or highlighting items listed in fields 38 and then pressing purchase button 39. In this case, screen 400 may be updated to display the purchased items.

To purchase the listed items, the consumer may enter and transmit credit or debit account identification and authorization from device 10 to server 20. Server 20 and/or Internet 30 may then process this information by consulting with the issuing financial institution for a transaction approval code. Once the approval code is received, server 20 may provide an indication that the transaction is successful such by issuing an e-receipt as described in commonly owned U.S. Provisional application No. 60/429,886 or in the more rudimentary form described U.S. Pat. No. 6,487,540 (both of which are hereby incorporated by reference in their entirety). Some or all of this information may be encrypted, encoded or otherwise manipulated to preserve privacy. The consumer may then exit the store without having to be checked out by a cashier. This allows the retailer to drastically reduce the number of cashiers, thereby resulting significant labor savings and allowing consumers to shop more quickly and efficiently.

After a purchase is completed, the consumer may also be presented with delivery or shipping options that may include home delivery and/or shipping to others via a commercial delivery service such as FedEX™ or UPS™ (not shown). The consumer may be prompted by system 100 to provide a shipping address and authorize the shipping costs with device 10.

In some embodiments, as the consumer prepares to exit the store, theft detection devices may scan the purchased items for product indicia such as an RFID tag or other known asset identification/tracking marker and confirm that the consumer's items match those actually purchased. This may be done, for example by comparing the results of an item scan with the consumer's e-receipt to make certain they match. In the case where a match is not found, an alarm may sound, security personnel may be alerted, or the consumer may be automatically prevented from exiting until any discrepancy is resolved. Server 20 may also interface with other asset recovery devices to perform this function (not shown). Thus, system 100 allows a consumer to quickly complete a purchase in a retailing environment and exit the store with few inconveniences while protecting the merchant's assets with minimal reliance on service personnel.

When a consumer selects a certain product, system 100 may inform the consumer that additional information, such as a feature list, or portions of an owner's manual are available. This may be done using any suitable visual, audio, or tactile alerting means such as a pop up window on screen 17 or a tone from speaker 19. The additional information may be sent automatically or with the consent of the consumer to device 10 along with the other information shown in field 38. Such product information may stored in memory 16 and may be accessed by clicking on an icon 40 associated with that product. In certain circumstances, the consumer may wish to retain the list of selected items and product information for future reference. This may be accomplished by pressing save product information button 37 which may transfer some or all of the product information to memory 16. This information may be subsequently (or concurrently) downloaded or transferred (e.g., by email) to a secondary computer system such as a personal computer or network computer for long term storage using link 11 or 13 (not shown).

The consumer may also select any other of the other feature fields 32 such as the “Browse Ads and Sale Items” field, the “Site Index” field or the “Store Floor Plan” field, if desired. Selecting the Site Index field may display certain information about system 100 and an overview of the software organization and navigational features such as how to navigate through menu screens using a particular device 10 (PDA, wireless phone, etc.). Selecting the Browse Ads and Sale Items field may allow the consumer to browse current ads and sale information. These materials may be organized by category or department to facilitate viewing by consumers.

The Store Floor Plan feature may display the current store's (and/or shopping mall's) layout to aid the consumer in reaching a particular destination (not shown). The floor plan may be static or interactive. With interactive floor plans, a consumer may be able to get information about a particular destination (such as information about a particular store or a particular location within a store) by selecting an interactive link displayed on screen 17. This prompts system 100 to download and display information about the selected location on device 10.

Consumers may also request and receive directions to particular destination within the store or mall. The displayed floor plan may also indicate the location of certain products or categories of products and concurrently display the consumer's current location within the floor plan (which may be calculated based on propagation delays between device 10 and one or more transceivers 24 or using a Global positioning Satellite (GPS) based system that communicates with device 10, etc. Product locations may be preprogrammed into system 100 or may be determined by polling asset markers on the products with transceiver 24). As the consumer travels within the store, his or her position may be constantly updated within the floor plan. This allows consumers to quickly locate and navigate to particular products or product categories within the store or mall, significantly reducing shopping time and increasing consumer comfort level with large stores or shopping malls.

Other features may include recommendation or compatibility features (not shown). These may be displayed as additional feature fields 32 on screen 200 or other screens. The recommendations feature may recommend products in response to a consumer request for a recommendation. For example, a consumer may pose a question to server 20 through device 10, such as “What is the best complete stereo system under $300?”. System 100 may respond to this inquiry with a product or products recommendation that answers the consumers inquiry and may include an independent product review such as an Edmunds™ or CNET.com™ review. System 100 may also ask for additional information or ask a consumer to answer a series of questions (such as a standardized questionnaire) and make a product recommendation based on the consumer's responses in order to provide a more focused recommendation.

Similarly, the compatibility feature may recommend products in response to a consumer inquiry for products compatible with a product the consumer already owns or is planning to purchase. For example, a consumer may already own a component stereo system or a digital camera and may want to find other components compatible with those products. For example, assume a consumer is looking for a cable compatible with a digital camera. The consumer may scan or enter information about the camera and into device 10. The consumer may then send this information to server 20 asking for compatible cables. Sever 20 may respond by sending list of compatible cables and descriptions to device 10.

Moreover, a consumer may use this feature as a way to configure a “virtual system” to ensure compatibility among multiple potential system components. For example, a consumer may wish to purchase a home entertainment system including multiple components such as a TV, DVD player, and stereo. The consumer may identify such selected products as described above and use system 100 to determine whether they are compatible with one another. This may be done in a number of ways. For example, a consumer may choose first and second products such as the TV and stereo above and send this information to server 20 to verify compatibility. In response to this request, server 20 may compare product characteristics or specifications such as input and output equipment, power requirements, communications protocols, etc. to determine if these products may be functionally connected to one another and if the proposed combination will work as desired. If the devices are found to be compatible, server 20 may suggest certain required equipment such as cables or software needed to successfully effect the proposed combination If, on the other hand, the selected items are found not to be compatible for some reason, server 20 may transmit information indicating incompatibility, the cause(s) of incompatibility and optionally suggesting potential solutions (e.g., by suggesting alternate components or components).

In addition to the functions described above, system 100 may also be used as an advertising aid for merchants. One way this may be accomplished is by transmitting advertising and promotional information to areas surrounding the store's location to attract potential customers. For example, in a shopping mall environment, a consumer may select an option on device 10 that allows it to receive information as he or she travels within a certain proximity of the store (from various transceivers 24). The consumer may receive and browse ads or other promotional material about that store'as he or she passes by. This allows merchants and restaurateurs to inobtrusively reach out to potential customers and allows consumers to learn about other merchants and products without having to actually visit a particular store.

One way by which such advertising information may be communicated is by using an open or dedicated “channel” that may exist on device 10. In general, the open channel may be selected or “turned on” by a consumer so device 10 may a receive transmissions from others. For example, the consumer may select to make his or her device available to content from third parties in a specific location, for example, based on the location of the device as determined by a GPS or other device locator. Such content may be, for example, information sent by merchants describing services to potential consumers. One advantage of this system is that the decision to receive such information resides with the consumer, allowing for exchange of useful information while providing the user with the ability to turn off the channel when such information is no longer desired.

The open channel or “advertising channel” facilitates transmission of information to consumers. For example, a consumer may open the advertising channel in a shopping mall, allowing merchants to provide merchandise information. In one embodiment, the consumer could enter a “screening” or filter word that would allow reception of certain information for transmission while blocking other unwanted information. For example, a consumer may enter a particular subject such as “shoes” and receive transmissions from stores providing shoes Alternatively, the filter word could be transmitted as a search term, requesting information.

Another application of system 100 is in the hotel/restaurant industry. For example, system 100 may be used as an aid to both consumers and service staff in restaurant to help perform various service functions such as answering consumer questions, order items, check on status of ordered items, and request and pay the bill. System 100 may be accessed by consumers and deployed as described above.

As described above, system 100 may provide a menu driven front end screen to device 10 suitable for restaurant applications. In this application, system 100 may be part of or interface with a Point-Of-Sales (POS) system or other food or beverage ordering system employed by the restaurant.

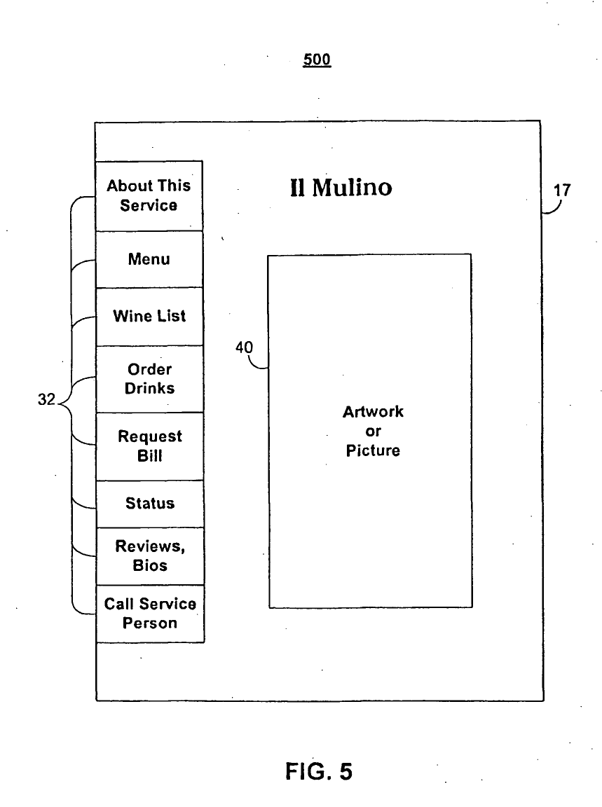

In FIG. 5, one possible embodiment of front end screen 500 is shown as presented on display screen 17. As shown, introductory screen 500 may include some form of artwork or introductory picture greeting the consumer. From the options on this introductory screen, the consumer may choose from among various system features by selecting from the feature fields 32 on the left-hand side of screen 17. This may be done using any of the methods described above. In restaurant embodiments, the consumer may be prompted to enter location information such as table number to ensure proper delivery of ordered items. This may be accomplished automatically by logging on to system 100 in a way transparent to the consumer (e.g., by ESN, by assignment, as described above in connection with the floor plan feature, or by other indicia).

As shown, the consumer may choose various available features to streamline or improve the dining experience. For example, selecting the “About This Service” field may provide information on how to use system 100 and what type of information and services are available through it.

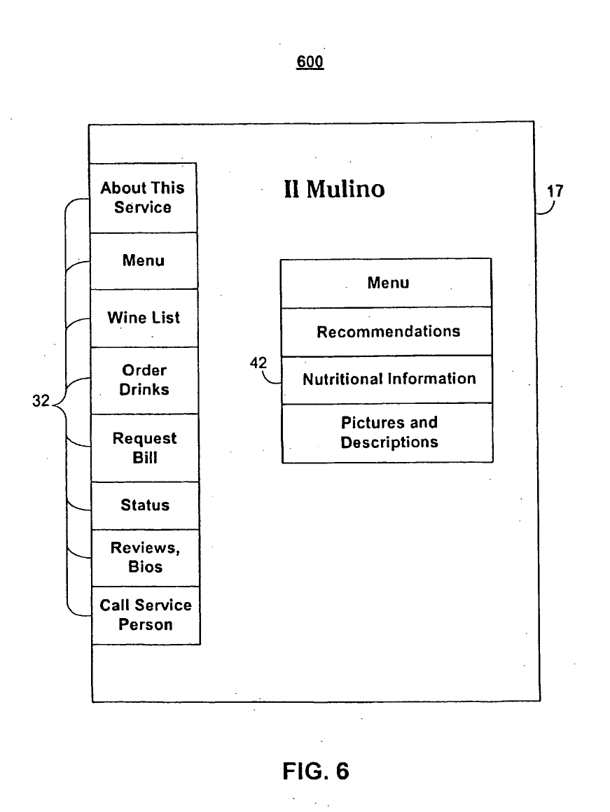

Selecting the “Menu” field allows the consumer to view the menu and obtain additional information about a particular dish. As shown in FIG. 6, this information may include a list categories 42 that a user may select including daily specials, recommendations from the chef, descriptions of a selected food items as well as nutritional information. One benefit of system 100 is that it allows the consumers to review detailed menu information without having to ask busy service personnel to repeat the menu information.

The requested information may be displayed in a static or interactive environment and may provide any suitable information responsive to a consumer inquiry such as images, video, and/or audio. For example, in response to a request for a description of a selected item, system 100 may provide text, an image, a series of images or video in conjunction with an audio description. For audio files, this may include, but is not limited to the following format types: analog; MIDI; MPEG; PCM; Windows Media Audio Code (WMA); WAV; or Adaptive Transform Acoustic Coding (ATRAC), etc. For video files, this may include, but is not limited to, converting to or from any of the following format types: analog; JPEG; MPEG; GIF; AVI, etc.

Requests for nutritional information may be presented in text or graphical format. In certain embodiments, consumers may be presented with the option of monitoring and tabulating the nutritional information associated with their order (not shown). This may be done to ensure food intake remains within certain parameters.

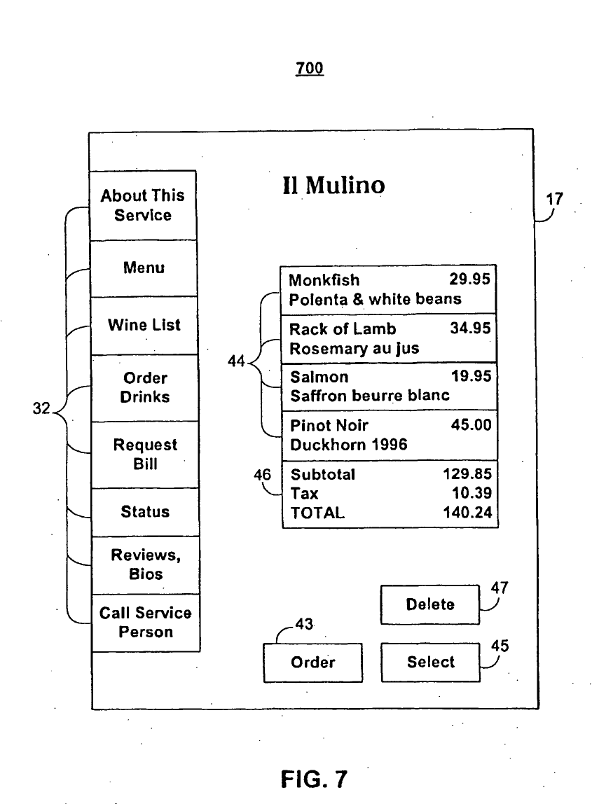

After viewing the menu, consumers may select food items using input 18. This may be accomplished by scrolling down and highlighting a menu option and pressing select button 23 (shown in FIG. 7). This generates a screen 700, which displays a list of the selected items. The consumer may then review the selected items, and either edit the selections using delete key 47 or order the items by pressing order key 43. As shown in FIG. 7, the list may contain a brief description of the ordered items. Once the consumer presses the order key 43, the order may be transmitted to the kitchen for preparation (or to an intermediate location for review and approval of a service person (not shown)). In the case where items other than food are ordered, (such as the bottle of wine shown in FIG. 7), those order may be routed to the appropriate location for processing and subsequent service.

Selecting other fields 32 allows the consumer access to other features available within system 100. For example, selecting the wine list field 32 allows the consumer to peruse and select items from this list (not shown). The selected item may then appear on screen 700 (e.g., the Pinot Noir shown in field 44). Although only one screen 700 is shown, it will be understood that that consumers may select and order additional items at any time and subsequent screens 700 may be created for that particular purchase. A running total of all items purchased, similar to screen 700, may also be provided upon consumer request (not shown). Furthermore, in certain embodiments, the consumer and service personnel may have access to the same electronic order allowing both parties to enter and order items (although the consumer may not have editing privileges once an item is ordered and may require service person intervention to remove or change previously ordered items).

Selecting other items from feature field 32 provides additional services. For example, selecting the “Order Drinks” field may allows to consumer to order or refresh drinks. This may accomplished by selecting a particular drink on display 17 or by simply reordering drinks already present on the bill (e.g., from an order previously placed by a service person). During the course of the meal, the consumer may request status information by selecting status field 32. This may provide estimated delivery times for ordered items, allowing the consumer make decisions based on such arrival times. The consumer may also make requests for faster or slower service (not shown). Selecting other feature fields 32 allows the consumer to view biographies of people involved with the restaurant such as the owner, chef, sommelier, or other items such as restaurant reviews, upcoming events or promotions, or other advertising. Selecting the “Call Service person” key alerts a waiter that personal service at a particular location is needed.

Selecting the “Request Bill” field 32 prompts system 100 to provide the consumer with an electronic copy of the bill. The consumer may then present credit or debit information as described above to pay the bill. This feature allows the user to quickly receive the bill without having to bother or wait for the attention of service personnel. In some embodiments, the service personnel may be alerted when the bill is requested to ensure proper payment is received and to say goodbye to exiting consumers.

It will be understood that the term service personnel as used herein is directed toward sales representatives, waiters, bartenders, cashiers and the like and is not to be confused with computer programmers or other technical people that may setup or maintain server 20 and any associated databases or perform any other non-service activity for a merchant.

Moreover, it will be appreciated that substantially the same system 100 may be used in many different applications with customized software, hardware, or other modifications suitable for a particular use and that system 100 and the associated screens described herein may be based on any suitable source software or operating system, including, but not limited to, Windows™, Linux™, OSX form IBM™, Visual Basic, C++, etc.

The above described embodiments of the present invention are presented for purposes of illustration and not of limitation, and the present invention is limited only by the claims which follow.

1. A method for electronically providing a consumer with accurate product information in a physical retailing environment without involving store service personnel; the method comprising:
allowing the consumer to electronically request the product information;
receiving the electronic product information request with a remote computer;
processing the electronic product information request with the remote computer;
electronically transmitting results of the electronic product information request to a mobile electronic device of the consumer; and
allowing the consumer to browse the results of the electronic product information request for use as a shopping aid.

2. The method of claim 1, wherein the electronically transmitting results further comprises transmitting text, image, or video results.

3. The method of claim 1, wherein the electronically transmitting results further comprises transmitting a feature list of a product identified in the product information request.

4. The method of claim 1, characterized by the use of a wireless phone, handheld computer, or personal digital assistant as the mobile electronic device of the consumer.
